(19) United States
(12) Patent Application Publication
(10) Pub. No.: US 2026/0196224 A1
(43) Pub. Date: Jul. 9, 2026

(54) VOICEPRINT MATCHING SUPPORT SYSTEM, VOICEPRINT MATCHING SUPPORT METHOD, AND PROGRAM

(71) Applicant: NEC Corporation, Tokyo (JP)

(72) Inventors: Akira GOTOH, Tokyo (JP); Shuji KOMELJI, Tokyo (JP); Yuko NAKANISHI, Tokyo (JP); Yuka KUGA, Tokyo (JP)

(73) Assignee: NEC Corporation, Tokyo (JP)

(21) Appl. No.: 19/132,454

(22) PCT Filed: Nov. 16, 2023
(86) PCT No.: PCT/JP2023/041303

§ 371 Date: May 23, 2025

(30) Foreign Application Priority Data
Dec. 5, 2022 (JP) 2022-194509

(51) Int. Cl. G10L 17/06; G10L 17/02

(52) U.S. Cl. CPC G10L 17/06; G10L 17/02

(57) ABSTRACT

Provided is a voiceprint matching support system capable of suppressing inclusion of a portion of an utterance of a person other than a target person in a case where presenting a portion of an utterance of the target person of voiceprint matching in voiceprint matching target voice data to a user. The voiceprint matching support system according to the present disclosure includes an input unit, an extraction unit, and a display unit. The input unit inputs sample voice data of the target person of voiceprint matching. The extraction unit extracts a time section in which the target person utters a voice from the voiceprint matching target voice data based on the sample voice data. The display unit presents the time section extracted by the extraction unit to the user.

### TECHNICAL FIELD

The present disclosure relates to a voiceprint matching support system, a voiceprint matching support method, and a program.

### BACKGROUND ART

In voiceprint matching for voiceprint identification or the like, an operator listens to and reviews the entire voice or the entire video including a voice and performs manual extraction in order to find a section in which a speaker whose is a verification target utters a voice.

In addition, Patent Literature 1 discloses a speaker search system for solving a problem that, in a case where speakers of detected voices are similar to each other, it is difficult to determine whether or not a detection result of a system for searching for a speaker indicates an utterance of a correct person to be searched. The speaker search system described in Patent Literature 1 includes a voice database that accumulates voice data, an optimal listening section detection unit, a speaker search unit, and a search result presentation unit. The optimal listening section detection unit detects an optimal listening section having a high speaker uniqueness from the accumulated voice data. The speaker search unit searches for, based on a voice or a speaker name input by a user, a voice or voice data uttered by the same speaker from the accumulated voice data. The search result presentation unit presents information regarding the voice data obtained by the speaker search unit together with information regarding the optimal listening section having a high speaker uniqueness of the voice data detected by the optimal listening section detection unit.

### CITATION LIST

### Patent Literature

Patent Literature 1: International Patent Publication No. WO 2014/155652

### SUMMARY OF INVENTION

### Technical Problem

As described above, the voiceprint matching for voiceprint identification and the like requires the operator to perform manual work, and such work requires a lot of time since the operator needs to repeatedly listen to and review the entire voice, and it can thus be easily imagined that accuracy of the voiceprint matching is lowered and the accuracy fluctuates due to fatigue.

Further, Patent Literature 1 describes that an utterance section of the same speaker is detected by clustering, but the technology described in Patent Literature 1 does not consider that utterances other than those of a specific speaker may overlap in the utterance section. Therefore, in the technology described in Patent Literature 1, it is not possible to present, to the user, a section in which a specific speaker utters a voice in a state in which utterances other than those of the specific speaker within the utterance section are excluded, and thus, there is room for improvement in information to be presented.

The present disclosure has been made to solve the above-described problems, and an object of the present disclosure is to provide a voiceprint matching support system, a voiceprint matching support method, and a program as follows. That is, an object of the present disclosure is to provide a voiceprint matching support system and the like capable of suppressing inclusion of a portion of an utterance of a person other than a target person in a case where presenting a portion of an utterance of the target person of voiceprint matching in voiceprint matching target voice data to a user.

### Solution to Problem

A voiceprint matching support system according to the present disclosure includes: an input unit configured to input sample voice data of a target person of voiceprint matching; an extraction unit configured to extract a time section in which the target person utters a voice from voiceprint matching target voice data based on the sample voice data; and a display unit configured to present the time section extracted by the extraction unit to a user.

Furthermore, a voiceprint matching support method according to the present disclosure includes: input processing of inputting sample voice data of a target person of voiceprint matching; extraction processing of extracting a time section in which the target person utters a voice from voiceprint matching target voice data based on the sample voice data; and display processing of causing a display apparatus to display the extracted time section to present the extracted time section to a user.

Furthermore, a program according to the present disclosure is a program for causing a computer to execute voiceprint matching support processing including: input processing of inputting sample voice data of a target person of voiceprint matching; extraction processing of extracting a time section in which the target person utters a voice from voiceprint matching target voice data based on the sample voice data; and display processing of causing a display apparatus to display the extracted time section to present the extracted time section to a user.

### Advantageous Effects of Invention

According to the present disclosure, it is possible to provide a voiceprint matching support system and the like capable of suppressing inclusion of a portion of an utterance of a person other than a target person in a case where presenting a portion of an utterance of the target person of voiceprint matching in voiceprint matching target voice data to a user.

### BRIEF DESCRIPTION OF DRAWINGS

FIG. 1 is a block diagram illustrating a configuration example of a voiceprint matching support system according to the present disclosure.

FIG. 2 is a flowchart for describing an example of a voiceprint matching support method in the voiceprint matching support system of FIG. 1.

FIG. 3 is a block diagram illustrating another configuration example of the voiceprint matching support system according to the present disclosure.

FIG. 4 is a diagram illustrating an example of a waveform of voiceprint matching target voice data to be processed by the voiceprint matching support system of FIG. 3.

FIG. 5 is a conceptual diagram conceptually illustrating an example of the voiceprint matching target voice data to be processed by the voiceprint matching support system of FIG. 3, and is a diagram schematically illustrating the waveform of the voiceprint matching target voice data of FIG. 4 for each speaker.

FIG. 6 is a diagram illustrating an example of a waveform of sample voice data used in the voiceprint matching support system of FIG. 3.

FIG. 7 is a conceptual diagram conceptually illustrating an example of the sample voice data used in the voiceprint matching support system of FIG. 3, and is a diagram schematically illustrating the waveform of the sample voice data of FIG. 6.

FIG. 8 is a diagram illustrating a display example of displaying an extracted time section for the waveform of the voiceprint matching target voice data of FIG. 4.

FIG. 9 is a diagram illustrating another display example of displaying the extracted time section for the waveform of the voiceprint matching target voice data of FIG. 4.

FIG. 10 is a diagram illustrating another display example of displaying the extracted time section for the waveform of the voiceprint matching target voice data of FIG. 4.

FIG. 11 is a diagram illustrating another display example of displaying the extracted time section for the waveform of the voiceprint matching target voice data of FIG. 4.

FIG. 12 is a flowchart for describing voiceprint matching target file creation work according to Comparative Example 1.

FIG. 13 is a flowchart for describing voiceprint matching target file creation work according to Comparative Example 2.

FIG. 14 is a diagram illustrating a hardware configuration example included in an apparatus.

### EXAMPLE EMBODIMENT

Hereinafter, an example embodiment will be described with reference to the drawings. To clarify description, in the following description and drawings, omission and simplification are made as appropriate. In each drawing, the same elements are denoted by the same reference signs, and redundant description will be omitted as necessary.

### First Example Embodiment

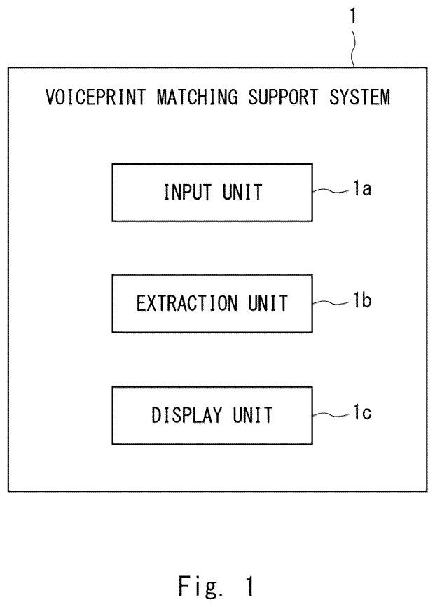

FIG. 1 is a block diagram illustrating a configuration example of a voiceprint matching support system according to the present disclosure. A voiceprint matching support system 1 according to the present disclosure illustrated in FIG. 1 can be a system that supports work of performing voiceprint matching by a user in a manner of presenting voice data that is a candidate for a voiceprint matching target to the user. The voiceprint matching support system 1 can be used in, for example, voiceprint identification work in identification in the police or the like, and various other works that require voiceprint matching.

For such support, the voiceprint matching support system 1 illustrated in FIG. 1 can include an input unit 1a, an extraction unit 1b, and a display unit 1c.

The input unit 1a inputs sample voice data of a target person of voiceprint matching. Here, the target person of voiceprint matching is assumed to be one person. The sample voice data can be voice data of one channel or a plurality of channels recorded so as to include an utterance of only the target person as a voiceprint target. Since the input of the sample voice data is referred to during the extraction unit 1b performs extraction, the sample voice data may be stored in the voiceprint matching support system 1 so as to be referable before the extraction is performed. Examples of an input source include a voice acquisition apparatus such as a microphone that acquires the voice data and a computer such as a server computer that stores the sample voice data acquired in advance. The voice acquisition apparatus or the computer can be included in the voiceprint matching support system 1. The input unit 1a is a part that inputs the sample voice data and transfers the sample voice data to the extraction unit 1b, and can include an input interface such as a communication interface for the transfer.

The extraction unit 1b extracts a time section in which the target person utters a voice from voiceprint matching target voice data based on the sample voice data. Since the extraction is based on the sample voice data, the extraction unit 1b analyzes both pieces of data and extracts a time section highly related to the sample voice data. For example, the extraction unit 1b can segment the sample voice data at predetermined time intervals, segment the voiceprint matching target voice data at the predetermined time intervals, and extract the time section in which the target person utters a voice for each predetermined time interval. Here, processing of recognizing a voice content of the voiceprint matching target voice data is unnecessary.

Furthermore, the extraction unit 1b can also extract the time section by using, for example, a learning model trained to receive the sample voice data and the voiceprint matching target voice data and output the time section in which the target person utters a voice. Any algorithm or the like of the learning model may be used, and data to be input may be segmented at the predetermined time intervals, for example.

The voiceprint matching target voice data can be recorded voice data of one channel or a plurality of channels. In particular, in the present example embodiment, the voiceprint matching target voice data is extracted based on the sample voice data of the target person, and thus, it is possible to extract the time section in which the target person utters a voice even in a case where the voiceprint matching target voice data is monaural voice data. Furthermore, the voiceprint matching target voice data can be data associated with video data, in other words, moving image data with audio.

Furthermore, the voiceprint matching target voice data can be stored in advance in a computer such as a server computer and acquired from the computer, or can be stored in a storage device provided in the voiceprint matching support system 1 and read from the storage device. The computer can also be included in the voiceprint matching support system 1.

Alternatively, the voiceprint matching target voice data can be data obtained by acquiring a conversation made in real time by the voice acquisition apparatus such as a microphone or data obtained by acquiring a content of a telephone conversation made in real time. In a case where the voiceprint matching target voice data is data acquired in real time as in such examples, processing of the extraction, and presentation by the display unit 1c can also be executed in real time.

The display unit 1c presents the time section extracted by the extraction unit 1b to the user. The display unit 1c can include a display apparatus and a display control unit that controls display on the display apparatus. The display apparatus only needs to be able to display an image, and can be a display such as a liquid crystal display (LCD) or an organic electro-luminescence (EL) display, or can be a projector. The display apparatus may be, for example, a display included in a smartphone, a tablet terminal, or the like.

Furthermore, the voiceprint matching support system 1 can be, for example, a server computer or a computer such as a personal computer or a smartphone. Specifically, the voiceprint matching support system 1 can be configured as a computer apparatus including hardware including, for example, one or more processors and one or more memories. Then, at least some of functions of the units in the voiceprint matching support system 1 may be implemented in such a way that the one or more processors operate according to a program read from the one or more memories.

In other words, the voiceprint matching support system 1 can include a control unit (not illustrated) that controls the entire voiceprint matching support system 1. The control unit can be implemented by, for example, a processor, a work memory, a non-volatile storage device storing a program, and the like. The processor may be, for example, a central processing unit (CPU), a graphics processing unit (GPU), or the like. The program can be a program for causing the processor to execute input processing in the input unit 1a, extraction processing in the extraction unit 1b, and display control processing in the display unit 1c. In addition, the voiceprint matching support system 1 can include the storage device that stores the input sample voice data, the voiceprint matching target voice data, information indicating the extracted time section, and the like, and, for example, the storage device provided in the above-described control unit can also be used as the storage device. The voiceprint matching support system 1 can also be implemented as an apparatus including dedicated hardware.

In addition, the voiceprint matching support system 1 is not limited to an example of being implemented as a single apparatus, and may be constructed as a plurality of apparatuses in which functions are distributed, and a method of distributing the functions is not limited. It is a matter of course that the display apparatus can be included as one of apparatuses to which the functions are distributed. In the case of constructing the voiceprint matching support system in which the functions are distributed to a plurality of apparatuses, each apparatus includes a control unit, a communication unit, and a storage unit as necessary. Furthermore, in this case, it is sufficient if the plurality of apparatuses is connected as necessary by wireless or wired communication to cooperate with each other to implement the functions described in the voiceprint matching support system 1.

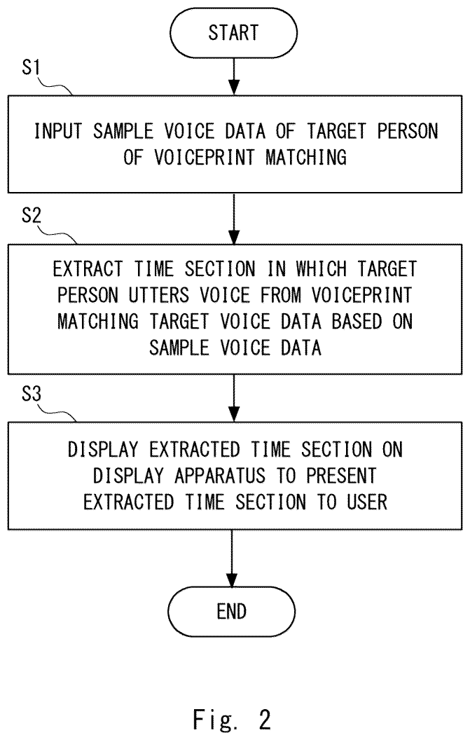

Next, a processing example of the voiceprint matching support system 1 will be described with reference to FIG. 2. FIG. 2 is a flowchart for describing an example of a voiceprint matching support method in the voiceprint matching support system 1 of FIG. 1.

The voiceprint matching support method executes the following voiceprint matching support processing. In the voiceprint matching support processing, the input processing of inputting the sample voice data of the target person of voiceprint matching is executed (step S1). Next, in the voiceprint matching support processing, the extraction processing of extracting the time section in which the target person utters a voice from the voiceprint matching target voice data based on the sample voice data is executed (step S2). Then, in the voiceprint matching support processing, the display processing of displaying the extracted time section on the display apparatus to present the extracted time section to the user is executed (step S3), and then, the processing ends. The above-described program can be a program that causes the computer to execute the voiceprint matching support processing including the input processing, the extraction processing, and the display processing described above.

As described above, the voiceprint matching support system 1 inputs the sample voice data of the target person (speaker) of voiceprint matching, analyzes and extracts the time section highly related to the sample voice data in the voiceprint matching target voice data, and returns time information indicating the time section to the user.

After such voiceprint matching support processing, the user who has received the presentation can select voice data to be subjected to voiceprint matching from the voiceprint matching target voice data in consideration of a content of the presentation, and can perform listening and reviewing work or execute voiceprint matching processing in a voiceprint matching apparatus. In the present example embodiment, with such support for voiceprint matching, the user can execute the voiceprint matching processing that imposes a high load on the listening and reviewing work of the user and a processing load of the voiceprint matching apparatus on the selected voice data. This voice data is data to be actually subjected to voiceprint matching, and the voiceprint matching target voice data to be processed by the extraction unit 1b is voice data for extracting the target of voiceprint matching. Therefore, the voiceprint matching target voice data can also be referred to as extraction target data, selection target data, or the like.

As described above, according to the present example embodiment, it is possible to suppress inclusion of a portion of an utterance of a person other than the target person, and to present a portion of an utterance of the target person of voiceprint matching in the voiceprint matching target voice data to the user.

Further details on the effect are as follows. In order to perform voiceprint matching, that is, speaker matching based on a voice, with high accuracy, it is necessary to extract a section in which only a specific speaker utters a voice. At present, in voiceprint matching work such as voiceprint identification, a time section suitable for voiceprint matching is extracted by listening to and reviewing long voice data. Therefore, there is a possibility that a heavy burden is imposed on the operator due to the long-time work and the subjective bias of the operator leads to inconsistent accuracy. On the other hand, an object of the present example embodiment is to extract a time section in which only the target person of voiceprint matching utters a voice as the specific speaker, particularly, a time section in which there is no overlap with an utterance of another person, and thus, the extraction is performed based on the sample voice data of the target person, and the time section is presented to the user. Since the extraction is based on the sample voice data of the target person, an extraction result with less overlap with an utterance of another person can be obtained. Then, the user can narrow down the time section to be subjected to voiceprint matching by listening and reviewing or the like by confirming a result of automatically extracting the time section in which the target person utters a voice in the voiceprint matching support system 1.

As described above, in the present example embodiment, it is possible to present, to the user, a section in which the specific speaker utters a voice in a state in which the overlap with an utterance of a person other than the specific speaker within an utterance section is suppressed. Therefore, according to the present example embodiment, in work that requires voiceprint matching such as voiceprint identification, the user who is the operator can listen to and review mainly the proposed section. As a result, the work can be more efficiently performed by reducing the need to listen to and review the entire utterance section. Therefore, according to the present example embodiment, it is possible to reduce labor for manual work of the user that is related to the extraction, prevent a decrease in accuracy, and prevent fluctuation in accuracy.

Furthermore, in the present example embodiment, the description has been given on the assumption that the number of target persons of voiceprint matching is one, but the number of target persons of voiceprint matching may be plural. In this case, a time section in which the plurality of persons has a conversation at the same time can be extracted from the voiceprint matching target voice data based on the sample voice data of each of the plurality of persons and presented to the user.

### Second Example Embodiment

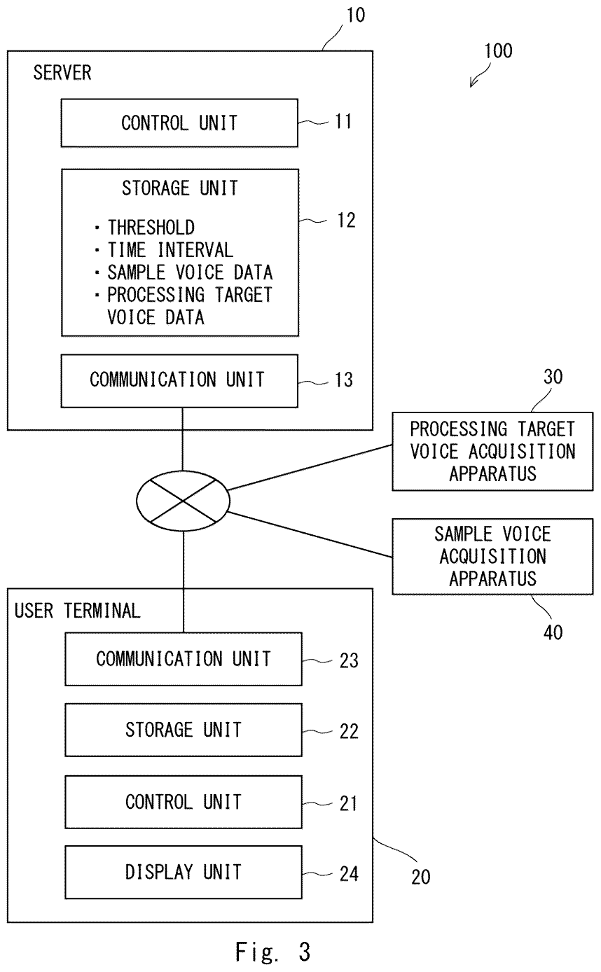

A second example embodiment will be described focusing on differences from the first example embodiment with reference to FIGS. 3 to 13, but various examples described in the first example embodiment can be applied. First, another configuration example of the voiceprint matching support system according to the present disclosure will be described with reference to FIG. 3. FIG. 3 is a block diagram illustrating another configuration example of the voiceprint matching support system according to the present disclosure.

As illustrated in FIG. 3, a voiceprint matching support system 100 according to the present disclosure can include a server computer (hereinafter, referred to as server) 10, a user terminal 20, a processing target voice acquisition apparatus 30, and a sample voice acquisition apparatus 40.

The server 10 can include a control unit 11, a storage unit 12, and a communication unit 13. The control unit 11 is a part that controls the entire server 10, and can be implemented by, for example, a processor such as a CPU or a GPU, a work memory, a non-volatile storage device that stores a program, and the like. The program can be a program for causing the processor to execute processing including input processing in an input unit 1a, extraction processing in an extraction unit 1b, and a part of display control processing in a display unit 1c. Here, a part of the display control processing can refer to processing of instructing the user terminal 20 via the communication unit 13 to display an extracted time section in the user terminal 20. The above-described program is read and executed by the control unit 11, whereby the server 10 can implement functions including an input function of the input unit 1a, an extraction function of the extraction unit 1b, a part of the display control function of the display unit 1c.

The storage unit 12 can be a storage device that stores sample voice data input from the sample voice acquisition apparatus 40, voiceprint matching target voice data (hereinafter, referred to as processing target voice data) input from the processing target voice acquisition apparatus 30, information indicating the extracted time section, and the like. The storage unit 12 can also store a threshold and a time interval used for the extraction processing.

The communication unit 13 can be a communication interface that communicates with the user terminal 20, the processing target voice acquisition apparatus 30, and the sample voice acquisition apparatus 40 via a wired or wireless network.

The user terminal 20 can be an information processing apparatus such as a personal computer or a smartphone, and can include a control unit 21, a storage unit 22, a communication unit 23, and a display unit 24.

The control unit 21 is a part that controls the entire user terminal 20, and can be implemented by, for example, a processor such as a CPU or a GPU, a work memory, a non-volatile storage device that stores a program, and the like. The program can be a program for causing the processor to execute processing including processing of accessing the server 10 via the communication unit 23 and a part of the display control processing in the display unit 1c. The above-described program is read and executed by the control unit 21, whereby the user terminal 20 can implement a function of executing the steps of processing. Here, a part of the display control function can refer to processing of displaying, in a case where an instruction to display the extracted time section is received from the server 10 via the communication unit 23, the extracted time section on the display unit 24 according to the instruction.

The storage unit 22 can be a storage device that stores various settings and the like related to the display of the time section. Examples of the settings can include a display setting in a user interface for displaying the time section. The communication unit 23 can be a communication interface that communicates with the server 10 via a wired or wireless network.

The processing target voice acquisition apparatus 30 is an apparatus that acquires the processing target voice data to be processed by the server 10 and transmits the processing target voice data to the server 10. The processing target voice acquisition apparatus 30 can be a telephone system, a network system capable of a voice call, a recording apparatus including a microphone, or the like.

The sample voice acquisition apparatus 40 is an apparatus that acquires the sample voice data to be used for the extraction processing in the server 10 and transmits the sample voice data to the server 10, and can be, for example, a recording apparatus including a microphone or the like.

With the above-described configuration, the voiceprint matching support system 100 can store the processing target voice data acquired by the processing target voice acquisition apparatus 30 in the server 10, and can store the sample voice data acquired by the sample voice acquisition apparatus 40 in the server 10. The order of the storage is not limited.

Then, as described as the function of the extraction unit 1b, the control unit 11 of the server 10 executes the extraction processing of extracting a time section in which a target person utters a voice from the stored processing target voice data based on the stored sample voice data.

Here, since the extraction processing in the first example embodiment is executed based on the sample voice data of the target person, voice data extracted from the processing target voice data includes voice data of the section in which the target person utters a voice, and the section is presented to a user. However, in the extraction processing in the first example embodiment, voice data of a section in which the target person has a conversation with another person may also be extracted.

Therefore, the extraction processing in the present example embodiment extracts, as the time section, a time section in which the target person utters a voice alone, that is, a time section excluding a section in which another person utters a voice.

Furthermore, the control unit 11 transmits, to the user terminal 20 via the communication unit 13, the instruction to display the extracted time section on the user terminal 20 in order to present the extracted time section to the user. In the user terminal 20, the communication unit 23 receives the instruction from the server 10, the control unit 21 performs control to display the time section on the display unit 24, and the display unit 24 displays the time section.

As a result, the user can mainly listen to and review the time section proposed by being displayed, so that the work can be more efficiently performed by reducing the need to listen to and review the entire utterance section. The information indicating the time section to be displayed is merely a proposal, and voiceprint matching for the time section is not automatically performed. It is a matter of course that, for example, in performing voiceprint matching for the time section, the user can select a time section that needs to be subjected to voiceprint matching in the user terminal 20, and cause a voiceprint matching apparatus (not illustrated) to perform voiceprint matching. The voiceprint matching apparatus can also be mounted on the server 10.

In the present example embodiment, by adopting the extraction processing as described above, voice data in a section in which the target person has a conversation with another person and an utterance of another person is mixed can be excluded from an extraction target, so that overlap with a voice of another person is further reduced as compared with the first example embodiment. That is, according to the present example embodiment, it is possible to prevent mixing with a voice of another person at the time of voiceprint matching.

As described above, according to the present example embodiment, it is possible to prevent inclusion of a portion of an utterance of a person other than the target person in a case where presenting a portion of an utterance of the target person of voiceprint matching in the processing target voice data to the user. In other words, in the present example embodiment, it is possible to present, to the user, a section in which a specific speaker utters a voice in a state in which overlap with an utterance of a person other than the specific speaker within the utterance section is excluded.

Therefore, according to the present example embodiment, the user who is the operator can mainly listen to and review the proposed section, so that the work can be more efficiently performed by reducing the need to listen to and review the entire utterance section as compared to the first example embodiment.

Furthermore, as the extraction processing, the control unit 11 can extract the time section based on a similarity score between a feature amount of the sample voice data and a feature amount of the processing target voice data. It is sufficient if an existing method is used as a method of calculating a type of the feature amount, the feature amount, and the similarity score. For example, the feature amount is calculated for each predetermined time interval, the similarity score is also calculated for each predetermined time interval, and the time section can also be extracted in units of predetermined time intervals. In this method, the similarity score is lowered in a section in which a voice of a person other than the target person indicated by the feature amount of the sample voice data is mixed among sections of the predetermined time intervals in the processing target voice data.

In particular, in the extraction processing, the control unit 11 may extract, as the time section, a section in which the similarity score in the processing target voice data is equal to or higher than a predetermined threshold. By adopting such extraction processing, the time section can be presented to the user in a state in which a section in which a voice of another person is mixed is excluded. As a result, it is possible to present, to the user, only information highly related to the target person (having a high similarity score), that is, only information indicating a section that needs to be listened to and reviewed, in an easily viewable manner.

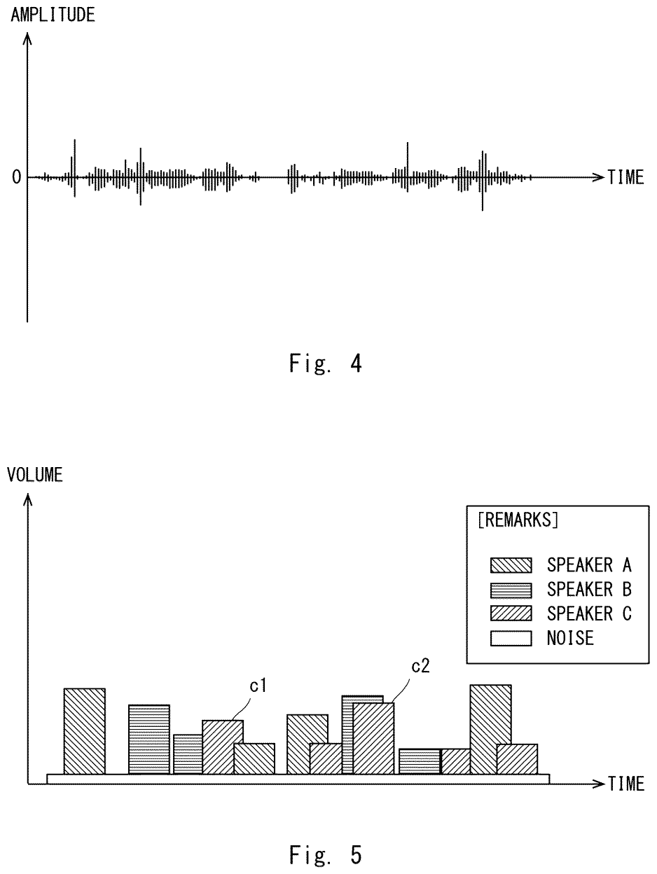

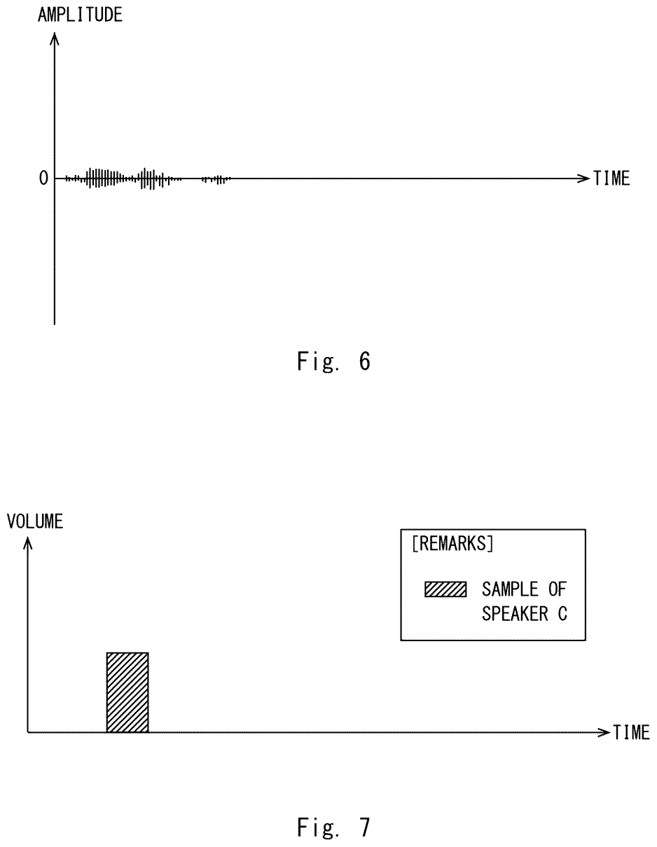

A specific example of such processing will be described with reference to FIGS. 4 to 11. FIG. 4 is a diagram illustrating an example of a waveform of the processing target voice data to be processed by the voiceprint matching support system 100. FIG. 5 is a conceptual diagram conceptually illustrating an example of the processing target voice data to be processed by the voiceprint matching support system 100, and is a diagram schematically illustrating the waveform of the processing target voice data of FIG. 4 for each speaker. FIG. 6 is a diagram illustrating an example of a waveform of the sample voice data used in the voiceprint matching support system 100. Furthermore, FIG. 7 is a conceptual diagram conceptually illustrating an example of the sample voice data used in the voiceprint matching support system 100, and is a diagram schematically illustrating the waveform of the sample voice data of FIG. 6.

The processing target voice data that is acquired by the processing target voice acquisition apparatus 30 and is to be processed by the server 10 has, for example, a waveform as illustrated in FIG. 4. The processing target voice data having the waveform illustrated in FIG. 4 can be divided into one or a plurality of speakers or one or a plurality of noises according to the feature amount by, for example, frequency analysis or clustering. FIG. 5 illustrates an example in which feature amounts of a speaker A, a speaker B, a speaker C, and noise are schematically illustrated as an example. Note that the feature amount is a value indicating various types of feature amounts including volume and sound pressure.

In addition, the sample voice data acquired by the sample voice acquisition apparatus 40 and used for the extraction processing in the server 10 has, for example, a waveform as illustrated in FIG. 6. FIG. 6 illustrates an example of the sample voice data of the speaker C. For comparison with FIG. 5, FIG. 7 schematically illustrates an example of the feature amount of the sample voice data having the waveform illustrated in FIG. 6. In addition, FIG. 5 is merely a drawing for describing an example of an overlapping state of a plurality of speakers and noise and is merely a drawing for describing that the feature amount of the speaker C illustrated in FIG. 7 can be extracted.

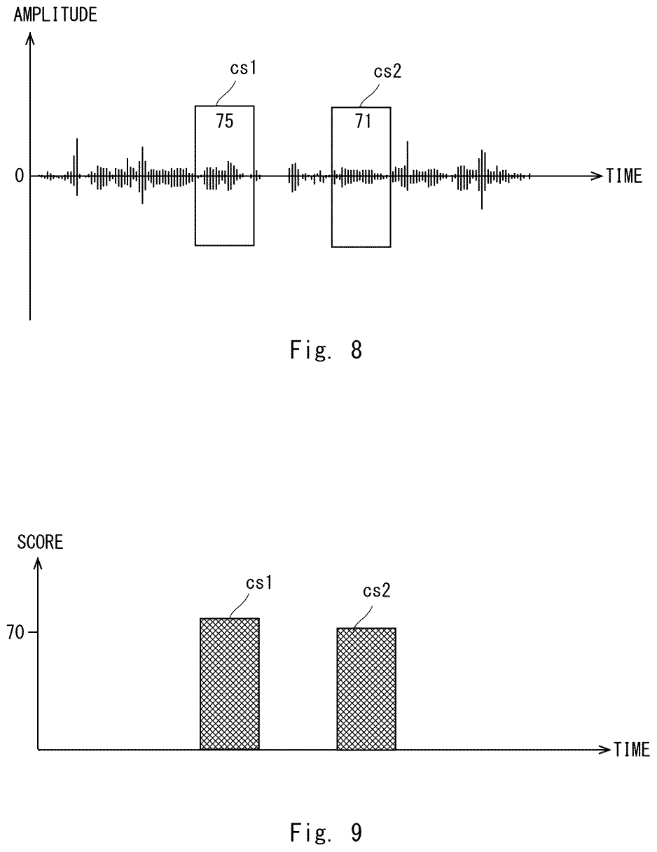

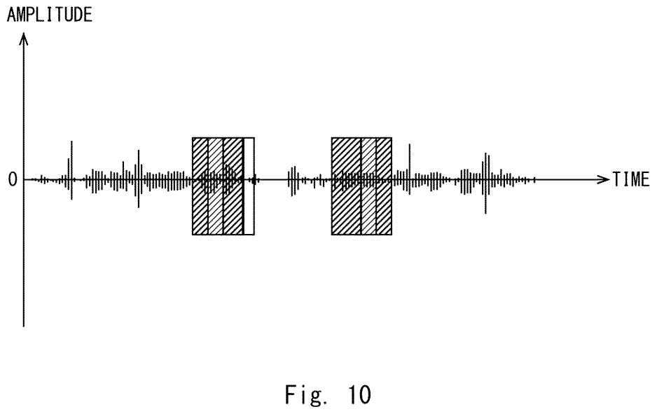

A time section display example will be described with reference to FIGS. 8 to 11. FIG. 8 is a diagram illustrating a display example of displaying the extracted time section for the waveform of the processing target voice data of FIG. 4. Furthermore, FIGS. 9 to 11 are diagrams illustrating other display examples of displaying the extracted time section for the waveform of the processing target voice data of FIG. 4.

As illustrated in FIG. 8, the server 10 can instruct the display unit 24 to display, in a display form different from those of other sections, the extracted time section in a state in which the waveform of the processing target voice data including a time axis corresponding to the processing target voice data is displayed. Then, the display unit 24 can perform such display. In the example of FIG. 8, rectangular regions cs1 and cs2 each indicating a calculation target time in which the similarity score is equal to or higher than the predetermined threshold are shown on the waveform. Here, an example in which the similarity score is a value in a range of 0 to 100, and the predetermined threshold is set to 70 is described. In FIG. 8, the rectangular regions cs1 and cs2 each indicating the calculation target time for the score value are regions corresponding to feature amounts c1 and c2 among feature amounts of the speaker C in FIG. 5, respectively.

The display form is not limited thereto, and the extracted time section can be displayed in a highlighted form. Alternatively, the higher the similarity score is, the darker the gradation of the extracted time section, or the extracted time section can be displayed in a different color. The latter example is an example in which the similarity score is divided into a plurality of threshold ranges and displayed in a different display form for each range. As a result, it is possible to display a time section with high relevance in a ranking format based on the similarity score, whereby the user can easily visually recognize the degree of relevance. A rank number can also be displayed. Furthermore, as another example of the display form, in the example of FIG. 8, the feature amount illustrated in FIG. 5 can be displayed instead of the waveform of FIG. 4.

In addition, although an example in which the waveform including the time axis is displayed has been described, it is also possible to simply display only the time axis without displaying the waveform. For example, as illustrated in FIG. 9, the rectangular regions cs1 and cs2 each indicating the calculation target time in which the similarity score is equal to or higher than the predetermined threshold can be displayed on the time axis. In FIG. 9, the rectangular regions cs1 and cs2 each indicating the magnitude of the similarity score (a height indicating the value) and the calculation target time for the similarity score are regions corresponding to the feature amounts c1 and c2 among the feature amounts of the speaker C in FIG. 5, respectively.

The display example of FIG. 8 also illustrates the value of the similarity score, and also corresponds to the following processing. That is, the server 10 can also instruct the display unit 24 to visualize and display the similarity score for at least the extracted time section in a state in which the waveform of the processing target voice data including the time axis corresponding to the processing target voice data is displayed. Then, the display unit 24 can perform such display. Here, the visualization of the similarity score may be visualizing the value of the similarity score itself as in the example of FIG. 8, or visualizing the value of the similarity score such that the magnitude indicated by the value of the similarity score can be recognized as in the example of FIG. 9.

As illustrated in FIG. 10, the server 10 can also cause the display unit 24 to display a density state of the similarity score for at least the extracted time section while displaying only the waveform of the processing target voice data including the time axis corresponding to the processing target voice data or the time axis. That is, the server 10 can instruct the display unit 24 to visualize and display the density state of a section having a high similarity score. The section having a high similarity score can refer to, for example, a section having a similarity score equal to or higher than another predetermined threshold. The another predetermined threshold may be set to be lower than the predetermined threshold. Then, the display unit 24 can perform such display.

In the example of FIG. 10, the density state may be displayed in a manner in which no hatching is applied in a case where the density is low, hatching is applied in a case where the density is high, and the higher the density, the darker the hatching. However, the example of FIG. 10 illustrates an example in which the predetermined time interval serving as a unit of extraction is shorter than that in the example of FIG. 8. The display of the density state is not limited to this example, and any display may be used as long as it is possible to visually recognize a dense portion having a high similarity score, and it is sufficient if the density state is expressed by a so-called one-dimensional heat map or in a display form similar thereto.

Furthermore, as can be seen from the difference between FIGS. 8 and 10, the server 10 can also include an interval setting unit that sets a time interval (the predetermined time interval) serving as the unit of extraction in the extraction processing. The interval setting unit can be mounted, for example, by storing an interval setting program for performing such setting in the storage unit 12 in a state of being executable by the control unit 11. As a result, the user can select a section to be listened to and reviewed while changing the time interval and changing a proposal content.

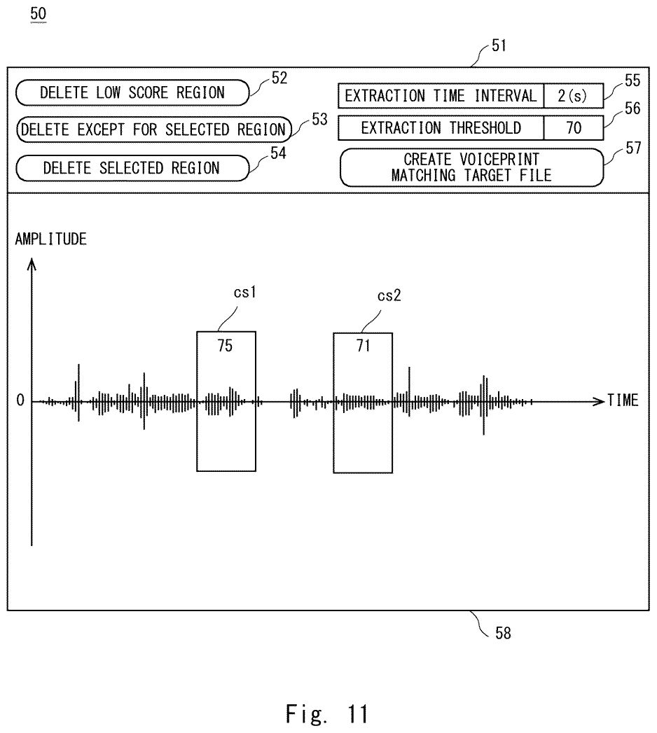

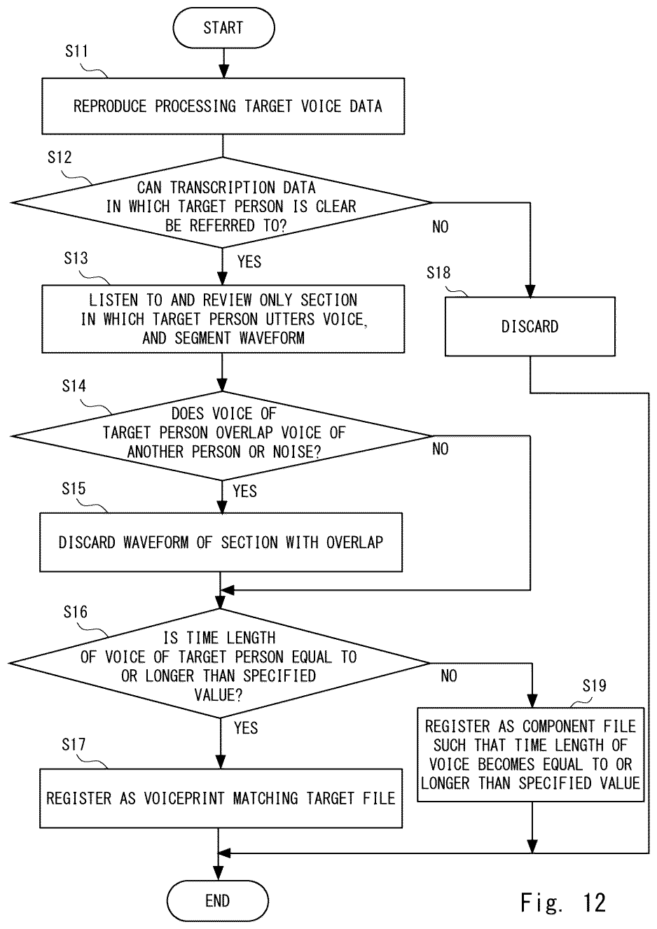

Such a setting of the time interval can be received by a user interface (UI). For example, the server 10 can present a UI 50 illustrated in FIG. 11 to the user terminal 20 voluntarily or in response to a request from the user terminal 20, and display the UI 50 on the display unit 24. In a case where the user inputs an interval in an input field 55 for the extraction time interval in the UI 50 displayed on the display unit 24, a graph 58 including information indicating the time section displayed in a region below the input field 55 is changed based on the input time interval and displayed.

In this example, an example in which the example of FIG. 8 is displayed in the graph 58 is described. However, other graphs such as the graph illustrated in FIG. 9 or FIG. 10 can be displayed, and a graph type can also be selected.

The UI 50 includes an input region 51 in addition to the graph 58, and the input field 55 can be included in the input region 51. In addition, for example, a button 52 for deleting a low score region, a button 53 for deletion except for a selected region, a button 54 for deleting a selected region, an extraction threshold input field 56, a voiceprint matching target file creation button 57, and the like can be provided in the input region 51.

Furthermore, the server 10 can include a threshold setting unit that sets the above-described predetermined threshold. The threshold setting unit can be mounted by, for example, storing a threshold setting program for performing such setting in the storage unit 12 in a state of being executable by the control unit 11. Such a setting of the predetermined threshold can also be received by the UI. For example, the server 10 can present the UI 50 including the extraction threshold input field 56 illustrated in FIG. 11 to the user terminal 20 voluntarily or in response to a request from the user terminal 20, and display the UI 50 on the display unit 24. In a case where the user inputs an interval in the extraction threshold input field 56 in the UI 50, the graph 58 displayed in a region below the extraction threshold input field 56 is changed and displayed based on the input extraction threshold.

Furthermore, the server 10 can include a deletion unit that deletes, from the processing target voice data, data in a section other than the extracted time section. The deletion unit can be mounted as one function of the control unit 11, and for example, can be mounted by storing a deletion program for performing such deletion in a state of being executable by the control unit 11. Such deletion can also be received by the UI.

For example, the server 10 can present the UI 50 including at least one of the buttons 52 to 54 as illustrated in FIG. 11 to the user terminal 20 voluntarily or in response to a request from the user terminal 20, and display the UI 50 on the display unit 24. The user can select one of the buttons 52 to 54 in the UI 50 displayed on the display unit 24 to delete a region indicated by the button from the processing target voice data. Here, in a case where the button 52 is selected, data corresponding to the similarity score lower than the predetermined threshold is deleted from the processing target voice data. The buttons 53 and 54 become selectable in a case where a time region is selected on the graph 58 in advance. In addition, at the time of the selection, a time section such as the region cs1 or cs2 may be configured to be able to be selected.

Furthermore, in the case of finally generating a voiceprint matching target file, data obtained by deleting such a region from the processing target voice data can be stored as the voiceprint matching target file by selecting the voiceprint matching target file creation button 57. A storage destination can be at least one of the storage unit 12 of the server 10 and the storage unit 22 of the user terminal 20, and may be another storage destination, and the storage destination may also be selectable in the UI 50.

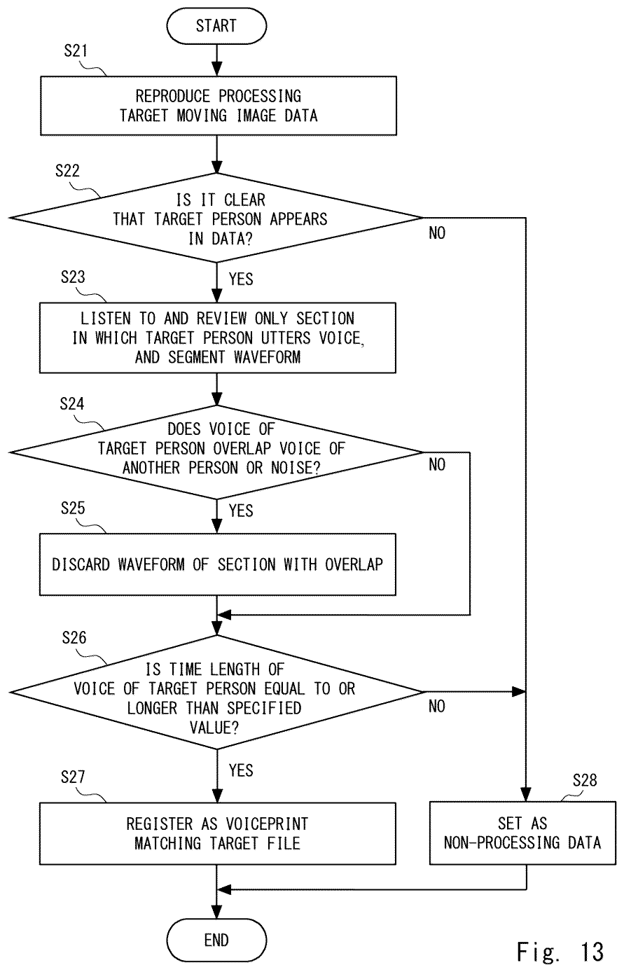

Next, in relation to the effects of the present example embodiment, work examples in which only recorded voice data is adopted as the processing target voice data, and moving image data is adopted as the processing target voice data will be described as a comparative example with reference to FIGS. 12 and 13. FIG. 12 is a flowchart for describing voiceprint matching target file creation work according to Comparative Example 1, and FIG. 13 is a flowchart for describing voiceprint matching target file creation work according to Comparative Example 2.

The work example illustrated in FIG. 12 illustrates a procedure of work of creating the voiceprint matching target file from processing target recorded voice data.

First, the user reproduces the processing target recorded voice data (step S11) and listens to the processing target recorded voice data. In addition, in Comparative Example 1, text transcription data is generated for a part of or the entire processing target recorded voice data and stored. The user determines whether or not the transcription data in which the target person is clear can be referred to (exist) for the processing target recorded voice data (step S12), discards the recorded voice data in a case where the transcription data cannot be referred to (step S18), and ends the work. In the case of YES in step S12, the user listens to and reviews only a section in which the target person utters a voice and performs work of segmenting the waveform (step S13).

Next, the user determines whether or not the voice of the target person overlaps a voice of another person or noise for the recorded voice data after the processing in step S13 (step S14), and discards a section in which the voice of the target person overlaps a voice of another person or noise in the recorded voice data in a case where the voice of the target person overlaps a voice of another person or noise (step S15). As a result, the recorded voice data after the processing in step S13 is partially deleted. Next, it is determined whether a time length of the voice of the target person is equal to or longer than a specified value such as 5 s (step S16). In the case of NO in step S14, the processing proceeds to step S16 without going through step S15. In the case of YES in step S16, the recorded voice data remaining so far is registered as the voiceprint matching target file (step S17), and the work ends. On the other hand, in the case of NO in step S16, the recorded voice data remaining so far is registered as a component file such that the time length becomes equal to or longer than the specified value (step S19), and the work ends.

Comparative Example 2 illustrated in FIG. 13 illustrates a procedure of work of creating the voiceprint matching target file from the moving image data including the recorded voice data.

First, the user reproduces processing target moving image data (step S21) and views and listens to the processing target moving image data. Since a video exists in Comparative Example 2, the user confirms the video, determines whether or not it is clear that the target person appears in the processing target moving image data (step S22), and if not clear, excludes the moving image data from processing (step S28), and ends the work. In the case of YES in step S22, the user listens to and reviews only a section in which the target person utters a voice and performs work of segmenting the waveform (step S23).

Next, the user determines whether or not the voice of the target person overlaps a voice of another person or noise for the moving image data after the processing in step S23 (step S24), and discards a section in which the voice of the target person overlaps a voice of another person or noise in the moving image data in a case where the voice of the target person overlaps a voice of another person or noise (step S25). As a result, the moving image data after the processing in step S23 is partially deleted. Next, it is determined whether a time length of the voice of the target person is equal to or longer than a specified value such as 5 s (step S26). In the case of NO in step S24, the processing proceeds to step S26 without going through step S25. In the case of YES in step S26, the voice data of the moving image data remaining so far is registered as the voiceprint matching target file (step S27), and the work ends. On the other hand, in the case of NO in step S26, the moving image data remaining so far is set as non-processing data (step S28), and the work ends. In a case of NO in step S26, the moving image data remaining so far may be registered as a component file such that the time length becomes equal to or longer than the specified value as in step S19, and then the work may end.

In both of Comparative Examples 1 and 2, it can be seen that it takes time and effort to create a file that is a voiceprint matching target. On the other hand, in the present example embodiment, by adopting the extraction processing as described above, voice data in a section in which the target person has a conversation with another person and an utterance of another person is mixed can be excluded from an extraction target. Therefore, according to the present example embodiment, the user who is the operator can mainly listen to and review the proposed section, so that the work can be more efficiently performed by reducing the need to listen to and review the entire utterance section as compared to Comparative Examples 1 and 2. In practice, for example, moving image data and voice data to be investigated often include voices other than that of the target person, and thus it can be said that the present example embodiment is very useful.

### Modified Example

While the present disclosure has been particularly shown and described with reference to example embodiments thereof, the present disclosure is not limited to the above-described example embodiments. Various changes that can be understood by those skilled in the art can be made to the configurations and details of the present disclosure within the scope of the present disclosure. Further, each example embodiment can be appropriately combined with other example embodiments.

Each of the drawings is merely an example to illustrate one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the figures for describing illustrative example embodiments are not necessarily mandatory, and some features or steps may be omitted. The order of the steps described in any of the figures may be changed as appropriate.

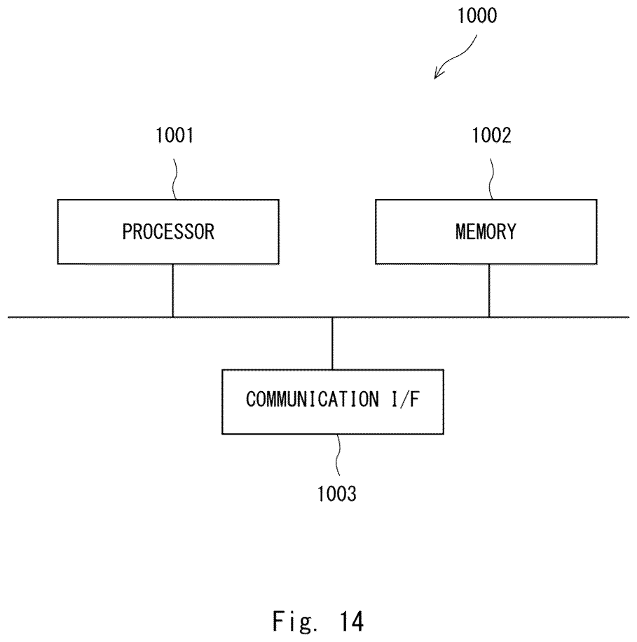

Furthermore, any one or a plurality of apparatuses included in the voiceprint matching support system according to the present disclosure can have the following hardware configuration. FIG. 14 is a diagram illustrating an example of a hardware configuration included in the apparatus.

An apparatus 1000 illustrated in FIG. 14 includes a processor 1001, a memory 1002, and a communication interface 1003. The function of each apparatus can be implemented by the processor 1001 reading a program stored in the memory 1002 and executing the program in cooperation with the communication interface 1003.

The above-described program includes a command group (or software codes) for causing a computer to perform one or more functions that have been described in the example embodiments in a case where the program is read by the computer. The program may be stored in a non-transitory computer readable medium or a tangible storage medium. As an example and not by way of limitation, the computer readable medium or the tangible storage medium includes a random-access memory (RAM), a read-only memory (ROM), a flash memory, a solid-state drive (SSD) or any other memory technology, a CD-ROM, a digital versatile disk (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, transitory computer-readable or communication media include electrical, optical, acoustic, or other forms of propagated signals.

Some or all of the above-described example embodiments may be described as in the following Supplementary Notes, but are not limited to the following Supplementary Notes.

### (Supplementary Note 1)

A voiceprint matching support system including:
an input unit configured to input sample voice data of a target person of voiceprint matching;
an extraction unit configured to extract a time section in which the target person utters a voice from voiceprint matching target voice data based on the sample voice data; and
a display unit configured to present the time section extracted by the extraction unit to a user.

### (Supplementary Note 2)

The voiceprint matching support system according to Supplementary Note 1, in which the extraction unit extracts, as the time section, a time section in which the target person utters a voice alone.

### (Supplementary Note 3)

The voiceprint matching support system according to Supplementary Note 1 or 2, further including a deletion unit configured to delete, from the voiceprint matching target voice data, data in a section other than the time section extracted by the extraction unit.

### (Supplementary Note 4)

The voiceprint matching support system according to any one of Supplementary Notes 1 to 3, in which the extraction unit extracts the time section based on a similarity score between a feature amount of the sample voice data and a feature amount of the voiceprint matching target voice data.

### (Supplementary Note 5)

The voiceprint matching support system according to Supplementary Note 4, in which the extraction unit extracts, as the time section, a section in which the similarity score in the voiceprint matching target voice data is equal to or higher than a predetermined threshold.

### (Supplementary Note 6)

The voiceprint matching support system according to Supplementary Note 5, further including a threshold setting unit configured to set the predetermined threshold.

### (Supplementary Note 7)

The voiceprint matching support system according to any one of Supplementary Notes 4 to 6, in which the display unit displays to visualize the similarity score for at least the time section extracted by the extraction unit in a state in which a time axis corresponding to the voiceprint matching target voice data or a waveform of the voiceprint matching target voice data including the time axis is displayed.

### (Supplementary Note 8)

The voiceprint matching support system according to any one of Supplementary Notes 4 to 7, in which the display unit displays to visualize a density state of a section having a high similarity score for at least the time section extracted by the extraction unit in a state in which the time axis corresponding to the voiceprint matching target voice data or the waveform of the voiceprint matching target voice data including the time axis is displayed. (Supplementary Note 9)

The voiceprint matching support system according to any one of Supplementary Notes 1 to 8, in which the display unit displays, in a display form different from display forms of other sections, the time section extracted by the extraction unit in a state in which a time axis corresponding to the voiceprint matching target voice data or a waveform of the voiceprint matching target voice data including the time axis is displayed.

### (Supplementary Note 10)

The voiceprint matching support system according to any one of Supplementary Notes 1 to 9, further including an interval setting unit configured to set a time interval that is a unit of extraction in the extraction unit.

### (Supplementary Note 11)

A voiceprint matching support method including:
input processing of inputting sample voice data of a target person of voiceprint matching;
extraction processing of extracting a time section in which the target person utters a voice from voiceprint matching target voice data based on the sample voice data; and
display processing of causing a display apparatus to display the extracted time section to present the extracted time section to a user.

### (Supplementary Note 12)

The voiceprint matching support method according to Supplementary Note 11, in which in the extraction processing, a time section in which the target person utters a voice alone is extracted as the time section.

### (Supplementary Note 13)

The voiceprint matching support method according to Supplementary Note 11 or 12, further including processing of deleting, from the voiceprint matching target voice data, data in a section other than the time section extracted in the extraction processing.

### (Supplementary Note 14)

The voiceprint matching support method according to any one of Supplementary Notes 11 to 13, in which the extraction processing is executed based on a similarity score between a feature amount of the sample voice data and a feature amount of the voiceprint matching target voice data.

### (Supplementary Note 15)

The voiceprint matching support method according to Supplementary Note 14, in which in the extraction processing, a section in which the similarity score in the voiceprint matching target voice data is equal to or higher than a predetermined threshold is extracted as the time section.

### (Supplementary Note 16)

The voiceprint matching support method according to Supplementary Note 15, further including processing of setting the predetermined threshold.

### (Supplementary Note 17)

The voiceprint matching support method according to any one of Supplementary Notes 14 to 16, in which the display processing includes processing of visualizing and displaying the similarity score for at least the time section extracted in the extraction processing in a state in which a time axis corresponding to the voiceprint matching target voice data or a waveform of the voiceprint matching target voice data including the time axis is displayed on the

### (Supplementary Note 18)

The voiceprint matching support method according to any one of Supplementary Notes 14 to 17, in which the display processing includes processing of visualizing and displaying a density state of a section having a high similarity score for at least the time section extracted in the extraction processing in a state in which the time axis corresponding to the voiceprint matching target voice data or the waveform of the voiceprint matching target voice data including the time axis is displayed on the display apparatus.

### (Supplementary Note 19)

The voiceprint matching support method according to any one of Supplementary Notes 11 to 18, in which the display processing includes processing of displaying, in a display form different from display forms of other sections, the time section extracted in the extraction processing in a state in which the time axis corresponding to the voiceprint matching target voice data or the waveform of the voiceprint matching target voice data including the time axis is displayed on the display apparatus.

### (Supplementary Note 20)

The voiceprint matching support method according to any one of Supplementary Notes 11 to 19, further including processing of setting a time interval that is a unit of extraction in the extraction processing.

### (Supplementary Note 21)

A program for causing a computer to execute voiceprint matching support processing including:
input processing of inputting sample voice data of a target person of voiceprint matching;
extraction processing of extracting a time section in which the target person utters a voice from voiceprint matching target voice data based on the sample voice data; and
display processing of causing a display apparatus to display the extracted time section to present the extracted time section to a user.

### (Supplementary Note 22)

The program according to Supplementary Note 21, in which in the extraction processing, a time section in which the target person utters a voice alone is extracted as the time section.

### (Supplementary Note 23)

The program according to Supplementary Note 21 or 22, in which the voiceprint matching support processing further includes processing of deleting, from the voiceprint matching target voice data, data in a section other than the time section extracted in the extraction processing.

### (Supplementary Note 24)

The program according to any one of Supplementary Notes 21 to 23, in which the extraction processing is executed based on a similarity score between a feature amount of the sample voice data and a feature amount of the voiceprint matching target voice data.

### (Supplementary Note 25)

The program according to Supplementary Note 24, in which in the extraction processing, a section in which the similarity score in the voiceprint matching target voice data is equal to or higher than a predetermined threshold is extracted as the time section.

### (Supplementary Note 26)

The program according to Supplementary Note 25, in which the voiceprint matching support processing includes processing of setting the predetermined threshold.

### (Supplementary Note 27)

The program according to any one of Supplementary Notes 24 to 26, in which the display processing includes processing of visualizing and displaying the similarity score for at least the time section extracted in the extraction processing in a state in which a time axis corresponding to the voiceprint matching target voice data or a waveform of the voiceprint matching target voice data including the time axis is displayed on the display apparatus.

### (Supplementary Note 28)

The program according to any one of Supplementary Notes 24 to 27, in which the display processing includes processing of visualizing and displaying a density state of a section having a high similarity score for at least the time section extracted in the extraction processing in a state in which the time axis corresponding to the voiceprint matching target voice data or the waveform of the voiceprint matching target voice data including the time axis is displayed on the

### (Supplementary Note 29)

The program according to any one of Supplementary Notes 21 to 28, in which the display processing includes processing of displaying, in a display form different from display forms of other sections, the time section extracted in the extraction processing in a state in which the time axis corresponding to the voiceprint matching target voice data or the waveform of the voiceprint matching target voice data including the time axis is displayed on the display apparatus.

### (Supplementary Note 30)

The program according to any one of Supplementary Notes 21 to 29, in which the voiceprint matching support processing includes processing of setting a time interval that is a unit of extraction in the extraction processing.

This application claims priority based on Japanese Patent Application No. 2022-194509 filed on Dec. 5, 2022, the entire disclosure of which is incorporated herein.

### REFERENCE SIGNS LIST

1, 100 VOICEPRINT MATCHING SUPPORT SYSTEM
1a INPUT UNIT
1b EXTRACTION UNIT
1c DISPLAY UNIT
10 SERVER
11 CONTROL UNIT
12 STORAGE UNIT
13 COMMUNICATION UNIT
20 USER TERMINAL
21 CONTROL UNIT
22 STORAGE UNIT
23 COMMUNICATION UNIT
24 DISPLAY UNIT
1000 APPARATUS
1001 PROCESSOR
1002 MEMORY
1003 COMMUNICATION INTERFACE

What is claimed is:

1. A voiceprint matching support system comprising:
at least one memory storing instructions; and
at least one processor configured to execute the instructions to do voiceprint matching support process, wherein the voiceprint matching support process includes:
inputting sample voice data of a target person of voiceprint matching;
extracting a time section in which the target person utters a voice from voiceprint matching target voice data based on the sample voice data; and
presenting the time section extracted by the extracting to a user on a display apparatus.

2. The voiceprint matching support system according to claim 1, wherein the extracting is extracting, as the time section, a time section in which the target person utters a voice alone.

3. The voiceprint matching support system according to claim 1, wherein the voiceprint matching support process further includes deleting, from the voiceprint matching target voice data, data in a section other than the time section extracted by the extracting.

4. The voiceprint matching support system according to claim 1, wherein the extracting is extracting the time section, based on a similarity score between a feature amount of the sample voice data and a feature amount of the voiceprint matching target voice data.

5. The voiceprint matching support system according to claim 4, wherein the extracting is extracting, as the time section, a section in which the similarity score in the voiceprint matching target voice data is equal to or higher than a predetermined threshold.

6. The voiceprint matching support system according to claim 5, wherein the voiceprint matching support process further includes setting the predetermined threshold.

7. (canceled)

8. (canceled)

9. The voiceprint matching support system according to claim 1, wherein the displaying is displaying, in a display form different from display forms of other sections, the time section extracted by the extracting in a state in which a time axis corresponding to the voiceprint matching target voice data or a waveform of the voiceprint matching target voice data including the time axis is displayed.

10. The voiceprint matching support system according to claim 1, wherein the voiceprint matching support process further includes setting a time interval that is a unit of the extracting.

11. A voiceprint matching support method comprising:
input processing of inputting sample voice data of a target person of voiceprint matching;
extraction processing of extracting a time section in which the target person utters a voice from voiceprint matching target voice data based on the sample voice data; and
display processing of causing a display apparatus to display the extracted time section to present the extracted time section to a user.

12. The voiceprint matching support method according to claim 11, wherein, in the extraction processing, a time section in which the target person utters a voice alone is extracted as the time section.

13. The voiceprint matching support method according to claim 11, further comprising processing of deleting, from the voiceprint matching target voice data, data in a section other than the time section extracted in the extraction processing.

14. The voiceprint matching support method according to claim 11, wherein the extraction processing is executed based on a similarity score between a feature amount of the sample voice data and a feature amount of the voiceprint matching target voice data.

15. The voiceprint matching support method according to claim 14, wherein, in the extraction processing, a section in which the similarity score in the voiceprint matching target voice data is equal to or higher than a predetermined threshold is extracted as the time section.

16. A non-transitory computer-readable medium storing a program for causing a computer to execute voiceprint matching support processing comprising:
input processing of inputting sample voice data of a target person of voiceprint matching;
extraction processing of extracting a time section in which the target person utters a voice from voiceprint matching target voice data based on the sample voice data; and
display processing of causing a display apparatus to display the extracted time section to present the extracted time section to a user.

17. The non-transitory computer-readable medium according to claim 16, wherein, in the extraction processing, a time section in which the target person utters a voice alone is extracted as the time section.

18. The non-transitory computer-readable medium according to claim 16, wherein the voiceprint matching support processing further includes processing of deleting, from the voiceprint matching target voice data, data in a section other than the time section extracted in the extraction processing.

19. The non-transitory computer-readable medium according to claim 16, wherein the extraction processing is executed based on a similarity score between a feature amount of the sample voice data and a feature amount of the voiceprint matching target voice data.

20. The non-transitory computer-readable medium according to claim 19, wherein, in the extraction processing, a section in which the similarity score in the voiceprint matching target voice data is equal to or higher than a predetermined threshold is extracted as the time section.

21. The voiceprint matching support system according to claim 4, wherein the displaying is displaying to visualize the similarity score for at least the time section extracted by the extracting in a state in which a time axis corresponding to the voiceprint matching target voice data or a waveform of the voiceprint matching target voice data including the time axis is displayed.

22. The voiceprint matching support system according to claim 4, wherein the displaying is displaying to visualize a density state of a section having a high similarity score for at least the time section extracted by the extracting in a state in which the time axis corresponding to the voiceprint matching target voice data or the waveform of the voiceprint matching target voice data including the time axis is displayed.
